(19) United States
(12) Patent Application Publication
(10) Pub. No.: US 2019/0054326 A1
(43) Pub. Date: Feb. 21, 2019

(54) FIREPROOF ASCENDING/DESCENDING MOBILE APPARATUS

(71) Applicant: CHEN-HSIN LIN, NEW TAIPEI CITY (TW)

(72) Inventor: CHEN-HSIN LIN, NEW TAIPEI CITY (TW)

(21) Appl. No.: 16/104,231

(22) Filed: Aug. 17, 2018

(30) Foreign Application Priority Data
Aug. 18, 2017 (TW) 106212226

(51) Int. Cl. A62B 1/02; A62B 7/00; B25J 5/00; B66B 1/30; B66B 11/02; B66B 7/06; B66B 5/02; E06C 1/34; B64C 39/02

(52) U.S. Cl. CPC A62B 1/02; A62B 7/00; B25J 5/00; B66B 1/30; B66B 11/0226; B64C 2201/128; B66B 5/02; E06C 1/34; B64C 39/024; B64C 2201/127; B66B 7/068

(57) ABSTRACT

A fireproof ascending/descending mobile apparatus includes a fireproof-material enclosure carrier device, a fireproof-material support device, a drive device, an uninterruptible power system, and a position controller. The drive device drives the fireproof-material enclosure carrier device to move on the fireproof-material support device and is arranged in the fireproof-material enclosure carrier device. The uninterruptible power system is electrically connected with the drive device and is arranged in the fireproof-material enclosure carrier device. The position controller is connected with the drive device to control a position of the fireproof-material enclosure carrier device and is arranged in the fireproof-material enclosure carrier device.

### FIELD OF THE INVENTION

The present invention relates to a fireproof mobile apparatus, and more particular to a fireproof ascending/descending mobile apparatus, including elevator.

### BACKGROUND OF THE INVENTION

Fire is one of the most commonly seen catastrophes. Fire events often occur in a very unexpected way, making it sometimes impossible to escape.

Further, fires often occur accompanying with flames that generate high temperature and smokes of flames. The flame of high temperature may burn living bodies, while the smoke may choke people. When occurring inside a building, both high temperature flames or thick smoke may hinder people from escaping and further injure or kill those people that do not escape in time and are not properly protected with protection means.

In addition, elevator devices that are commonly installed inside buildings may stop operation due to power failure in a fire accident and users of the elevator may get trapped inside the elevator. Further, the high temperature generated by fire may cause undesired deformation of the elevators.

Thus, it is urgently desired to provide a fireproof ascending/descending mobile apparatus that helps people to escape.

### SUMMARY OF THE INVENTION

In view of the above problems, the present invention provides a fireproof ascending/descending mobile apparatus, which comprises at least one fireproof-material enclosure carrier device, at least one fireproof-material support device, at least one drive device, at least one uninterruptible power system, and at least one position controller. The at least one drive device drives the at least one fireproof-material enclosure carrier device to cause the at least one fireproof-material enclosure carrier device to move on the at least one fireproof-material support device and is arranged in the at least one fireproof-material enclosure carrier device. The at least one uninterruptible power system is electrically connected with the at least one drive device and is arranged in the at least one fireproof-material enclosure carrier device. The at least one position controller is connected with the at least one drive device to control a position of the at least one fireproof-material enclosure carrier device and is arranged in the at least one fireproof-material enclosure carrier device.

The present invention also provides a fireproof ascending/descending mobile apparatus, which comprises at least one fireproof-material enclosure carrier device, at least one fireproof-material support device, at least one drive device, at least one uninterruptible power system, at least one first wireless control device and at least one second wireless control device. The at least one drive device drives the at least one fireproof-material enclosure carrier device to cause the at least one fireproof-material enclosure carrier device to move on the at least one fireproof-material support device and is arranged in the at least one fireproof-material enclosure. The at least one uninterruptible power system is electrically connected with the at least one drive device and is arranged in the at least one fireproof-material enclosure. The at least one first wireless control device is arranged in the at least one fireproof-material enclosure carrier device to transmit at least one signal. The at least one second wireless control device is arranged in the at least one fireproof-material enclosure and is connected with the at least one drive device to receive the at least one signal to control a position of the at least one fireproof-material enclosure carrier device.

Based on the above, the present invention provides fireproof ascending/descending mobile apparatus that includes all sorts of functions for protecting users, preventing the users from injury caused by high temperature flames and smoke, and also for detecting environmental changes and activating, in advance, a situation-responding mechanism as early as possible when a fire occurs in order to protect and help the users to escape immediately. Further, the present invention comprises an uninterruptible power system which continuously supplies electrical power to maintain the operation of the drive device even when the fire causes power failure.

### BRIEF DESCRIPTION OF THE DRAWINGS

FIG. 1A is a perspective view showing a fireproof ascending/descending mobile apparatus according to an embodiment of the present invention;

FIG. 1B is a schematic view showing a fireproof ascending/descending mobile apparatus according to another embodiment of the present invention;

FIG. 1C is a schematic view illustrating use of the fireproof ascending/descending mobile apparatus according to the present invention;

FIGS. 2A-2D are schematic views illustrating a fireproof ascending/descending mobile apparatus according to the present invention including an escape exit means; and

FIGS. 3A-3D are schematic views illustrating a fireproof ascending/descending mobile apparatus according to the present invention including a flying device.

### DETAILED DESCRIPTION OF THE PREFERRED EMBODIMENTS

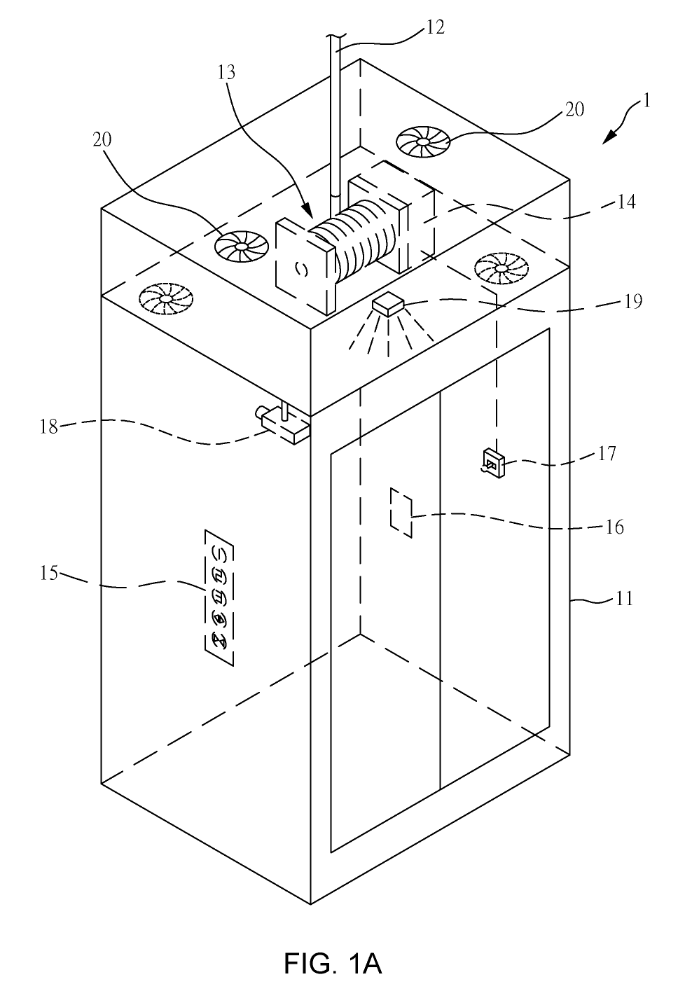

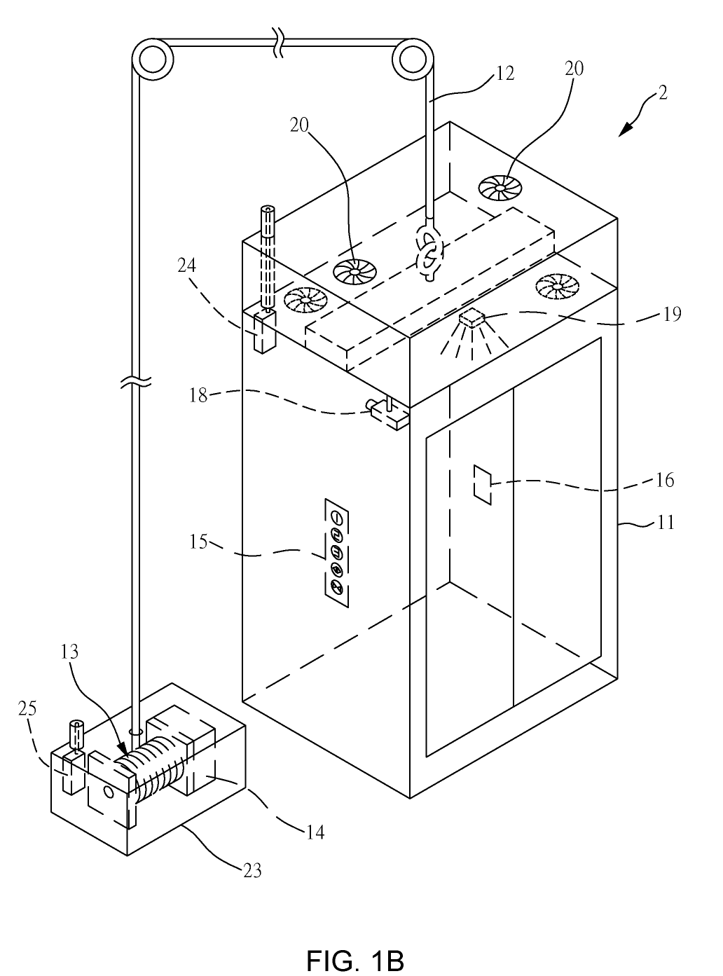

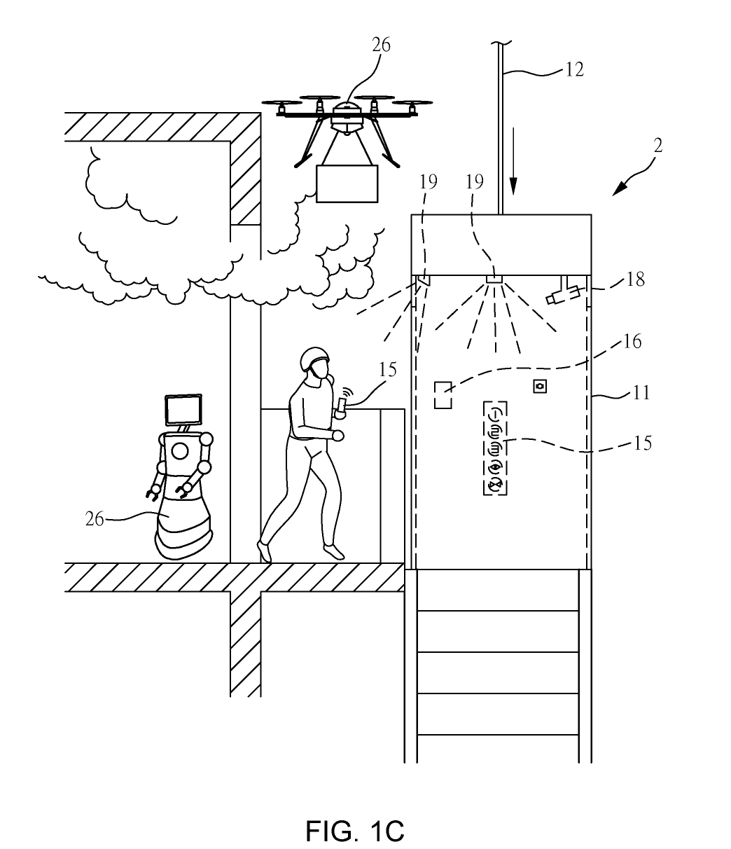

Referring to FIG. 1A, a perspective view is provided to show a fireproof ascending/descending mobile apparatus according to an embodiment of the present invention. The fireproof ascending/descending mobile apparatus 1 according to the present invention comprises at least one fireproof-material enclosure carrier device 11, at least one fireproof-material support device 12, at least one drive device 13, at least one uninterruptible power system (UPS) 14, and at least one position controller 15. The at least one drive device 13 drives the at least one fireproof-material enclosure carrier device 11 to cause the at least one fireproof-material enclosure carrier device 11 to move on the at least one fireproof-material support device 12 and is arranged inside the at least one fireproof-material enclosure carrier device 11. The at least one uninterruptible power system 14 is electrically connected with the at least one drive device 13, and is arranged in the at least one fireproof-material enclosure carrier device 11. The at least one position controller 15 is connected with the at least one drive device 13 to control a position of the at least one fireproof-material enclosure carrier device 11 and is arranged in the at least one fireproof-material enclosure carrier device 11.

Further, the drive device and the uninterruptible power system may alternatively be arranged at a location nearby the fireproof-material enclosure carrier device, such as ground, floor deck, and ceiling, and is enclosed and housed by a fireproof-material enclosure. Referring to FIG. 1B, a perspective view is provided to show a fireproof ascending/descending mobile apparatus according to another embodiment of the present invention. The present invention provides another fireproof ascending/descending mobile apparatus 2, which comprises at least one fireproof-material enclosure carrier device 11, at least one fireproof-material support device 12, at least one drive device 13, at least one uninterruptible power system 14, at least one first wireless control device 24, and at least one second wireless control. device 25. The at least one drive device 13 drives the at least one fireproof-material enclosure carrier device 11 to cause the at least one fireproof-material enclosure carrier device 11 to move on the at least one fireproof-material support device 12 and is arranged in at least one fireproof-material enclosure 23. The at least one uninterruptible power system 14 is electrically connected with the at least one drive device 13, and is arranged in the at least one fireproof-material enclosure 23. The at least one first wireless control device 24 is arranged in the at least one fireproof-material enclosure carrier device 11 to transmit at least one signal. The at least one second wireless control device 25 is arranged in the at least one fireproof material enclosure 23 and is connected with the at least one drive device 13 to receive the at least one signal to control a position of the at least one fireproof-material enclosure carrier device 11. The first wireless control device 24 and the second wireless control device 25 can be any wireless communication technology that is commonly used in transmitting and receiving a signal and may include, for example a radio frequency (RF) transmitter/receiver, a radio frequency identification (RFID) transmitter receiver, a far infrared transmitter/receiver, an infrared transmitter receiver and a Bluetooth transmitter/receiver

As such the present invention provides the drive device 13, the uninterruptible power system 14, and the position controller 15 that are arranged in the fireproof-material enclosure carrier device 11 or the fireproof-material enclosure 23, so that when a fire accident occurs, the operations of these devices are protected from being influenced by the fire.

The fireproof-material support device 12 comprises a fireproof-material support rail and/or fireproof-material suspension cable. The two can be provided together, or can be provided separately. The fireproof-material support rail and/or the fireproof-material suspension cable is arranged in the interior and/or exterior of a building. The fireproof-material support rail may comprise a curved rail, an extendible rail, and/or a combination rails. The fireproof-material support rail can be mounted on a wall surface of a building or can be arranged in a suspending or supported manner.

Following the description above, in one embodiment of the present invention, the fireproof-material enclosure carrier device 11 comprises an elevator carrier car, and the elevator carrier car is arranged in the interior or exterior of a building, and in addition, the fireproof-material support rail or the fireproof-material suspension cable is provided as desired and required so that the elevator carrier car may move on the fireproof-material support rail or is moved by the fireproof-material suspension cable. Further, since the elevator carrier car comprises a fireproof material, when a fire occurs, users may move into the elevator carrier car for protection from high temperature flame's and thick smoke and to control the elevator carrier car to move immediately away from the site where the fire occurs to serve as an emergency escape measure. Further, the elevator carrier car comprises a cab and a machine box. The cab provides a space for accommodating the users, while the machine box accommodates therein all sorts of power facility, control circuitry, and mechanisms for protection against burning down by the fire. The machine box is arranged in above the cab and they may be arranged in an integrated manner as a unitary structure, or may be arranged separately.

The position controller 15 comprises wired or wireless buttons arranged in the fireproof-material enclosure carrier device 11, or alternatively a handheld controller (as shown in FIG. 1C) may be provided, allowing a user to call and control, through wireless control as staying in the exterior, the fireproof-material enclosure carrier device 11 to move to a location corresponding to a desired floor.

The fireproof ascending/descending mobile apparatus 1 further comprises at least one controller 17, which is connected with the at least one drive device 13 by wire or wirelessly. The controller 17 is operable to control a moving speed of the at least one fireproof material enclosure carrier device 11. Further, it is noted that an existing elevator is generally not provided with an additional device that allows a user to control the speed of the elevator; however, in a fire, the additionally provided controller 17 according to the present invention allows the user to control, as desired, the moving speed of the at least one fireproof-material enclosure carrier device 11 in order to achieve quick or fast escape from the site of the catastrophe. That is, the controller 17 is operable to control a faster moving speed than normal speed of the at least one fireproof-material enclosure carrier device 11 in order to be able to escape in shorter timing.

Following the description above, the fireproof ascending/descending mobile apparatus 1 comprises at least one position sensor (not shown), which is connected with the at least one drive device 13 and is arranged in the at least one fireproof-material enclosure carrier device 11 or a building for detecting a vertical position of the at least one fireproof-material enclosure carrier device 11. Further, when the fireproof-material enclosure carrier device 11 moves and reaches a predetermined height or vertical location, the position sensor is activated to control the at least one drive device 13 in order to further control the speed of the at least one fireproof-material enclosure carrier device 11, wherein the predetermined height is a height where human body, if falling therefrom, would not be injured in other words, with the operations of the position sensor and the above-described controller 17, a descending speed of the fireproof-material enclosure carrier device 11 can be controlled such that a user is allowed to fast descend to a height that is close to the ground surface, which is the predetermined height, without being hurt, to escape.

The fireproof ascending/descending mobile apparatus 1 further comprises at least one monitoring device 18, which is arranged on the fireproof-material enclosure carrier device 11 and/or an exterior location of an elevator gate of at least one floor, in order to monitor the conditions of the interior and the exterior the fireproof ascending/descending mobile apparatus 11 to ensure riding safety of the user. The monitoring device 18 can be remotely controlled and can be arranged in a wired or wireless manner.

The fireproof ascending/descending mobile apparatus 1 further comprises at least one temperature sensor 16, at least one smoke sensor, and/or at least one flame sensor, which are arranged in the interior of a building and/or the exterior of the at least one fireproof-material enclosure carrier device 11 to detect an environmental temperature in the interior of the building and/or an environmental temperature in the exterior of the at least one fireproof-material enclosure carrier device 11. The at least one temperature sensor 16, the at least one smoke sensor and/or the at least one flame sensor are electrically connected with are non-electrically connected with the at least one drive device 13, to drive, according to the interior environmental temperature of the building and/or the exterior environmental temperature of the at least one fireproof-material enclosure carrier device 11, the at least one drive device 13 to move to a location corresponding to at least one floor of the building. The temperature sensor 16, the smoke sensor and the flame sensor can be selectively to install one or at least two of them in order to detect if flame or smoke occur in the interior environment of the building and/or in the exterior of the at least one fireproof-material enclosure carrier device 11, so that when one of the floors of the building has such a situation of smoke or flame or high temperature, the fireproof-material enclosure carrier device 11 automatically moves to such a floor to allow users to fast move into and hide in the fireproof-material enclosure carrier device 11 whereby time that it may take for waiting the fireproof-material enclosure carrier device 11 to move to such a floor can be saved. In addition, the at least one temperature sensor 16, the at least one smoke sensor, or at least one flame sensor can further transmit the sensing information to fire units.

The fireproof ascending/descending mobile apparatus 1 further comprises at least one temperature lowering device 19, which is arranged on the at least one fireproof-material enclosure carrier device 11 and is connected with the at least one temperature sensor 16, the at least one smoke sensor and/or the at least one flame sensor, in order to activate according to a preset temperature and/or a preset condition of the at least one temperature sensor 16, the at least one smoke sensor and/or the at least one flame sensor. In other words, when the at least one temperature sensor 16, the at least one smoke sensor and/or the at least one flame sensor detects an exterior temperature of the fireproof-material enclosure carrier device 11 is excessively high, such as exceeding a preset temperature of 60° C., or a fire occurs in the interior of the building and flames are caused, indicating the fire may spread to an environment around the exterior of the fireproof-material enclosure carrier device 11 or spread to a surface of the fireproof-material enclosure carrier device 11, the temperature lowering device 19 may thus automatically activate to lower down temperature and/or extinguishing fire. The temperature lowering device 19 may comprise a fire extinguisher, a water sprinkler, or a water reservoir.

The fireproof ascending/descending mobile apparatus further comprises at least one ventilation device 20, which is arranged on the at least one fireproof-material enclosure carrier device 11. The ventilation device 20 comprises a fan and a chimney and is provided to block, guide, and/or blow away thick smoke and prevent the smoke from flowing into the interior of the fireproof-material enclosure carrier device 11.

Further, in addition to protection against burning by high temperature flames through the temperature lowering measure, the fireproof ascending/descending mobile apparatus 1 may provide protection against injury caused by smoke. For example, the fireproof ascending/descending mobile apparatus 1 further comprises at least one air supply and filtration device (not shown), which is arranged on the at least one fireproof-material enclosure carrier device 11. The air supply and filtration device comprises at least one gas mask, at least one active carbon mask and/or at least one oxygen mask.

The fireproof ascending/descending mobile apparatus 1 further comprises at least one burning suppressing gas device (not shown), which is arranged in the fireproof-material enclosure carrier device 11 and/or an exterior at an elevator gate of at least one floor to help suppress burning, of fire through automatic activation at an excessively high temperature. The burning suppressing gas device comprises a fire extinguisher, a carbon dioxide canister, and the like.

The fireproof ascending/descending mobile apparatus 1 further comprising at least one remote control AI robot 26, including airplane and/or ground robot equipped with camera and rescue devices. The remote control AI robot 26 is provided to transmit images to fire units and provided rescue items in the event of a fire. Each of the remote control AI robots 26 could be functioned intelligent automation or option to be controlled from a remote control center.

The fireproof ascending/descending mobile apparatus 1 further comprising at least one side door (not shown), which is connected with the at least one mechanical escape device, including stair or slide, to offer apparatus user with optional choice with emergency button control (not shown) to use the mechanical escape device at anytime.

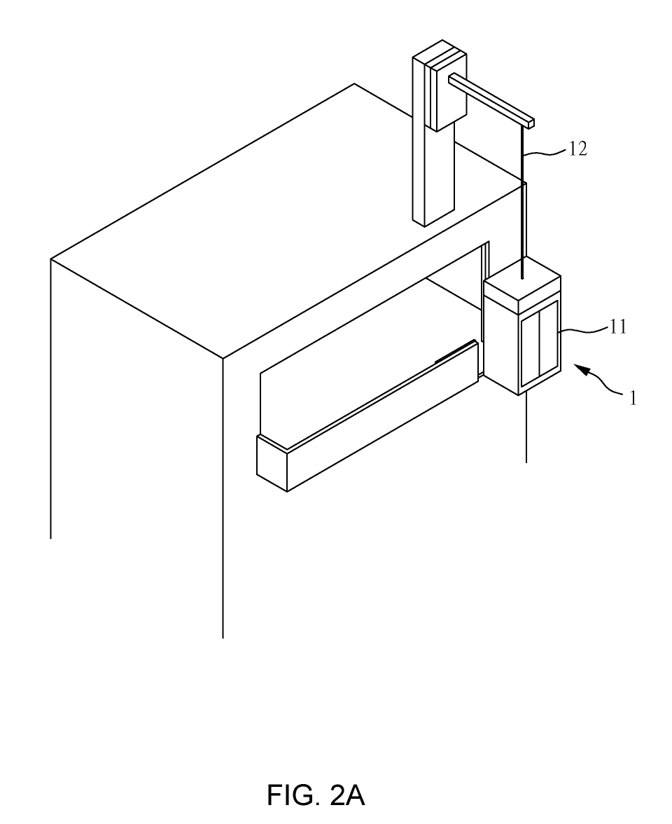

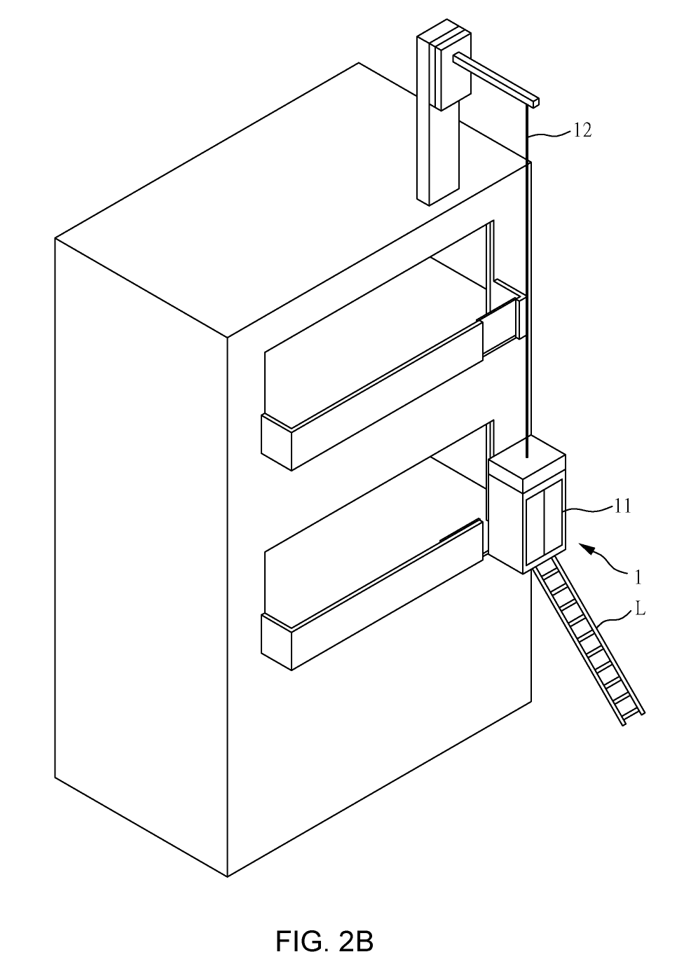

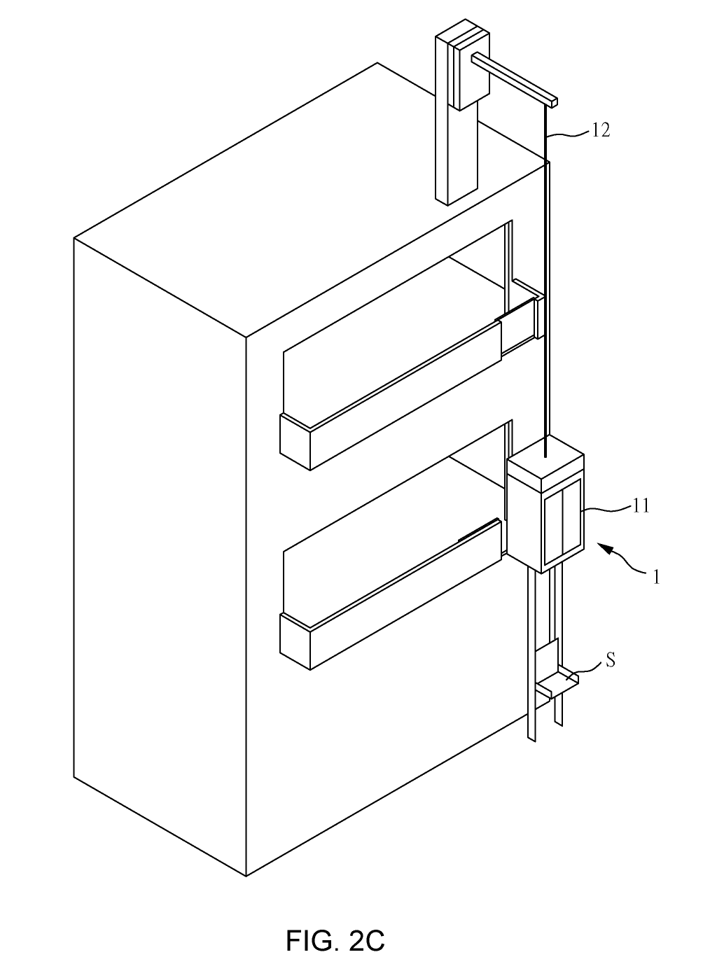

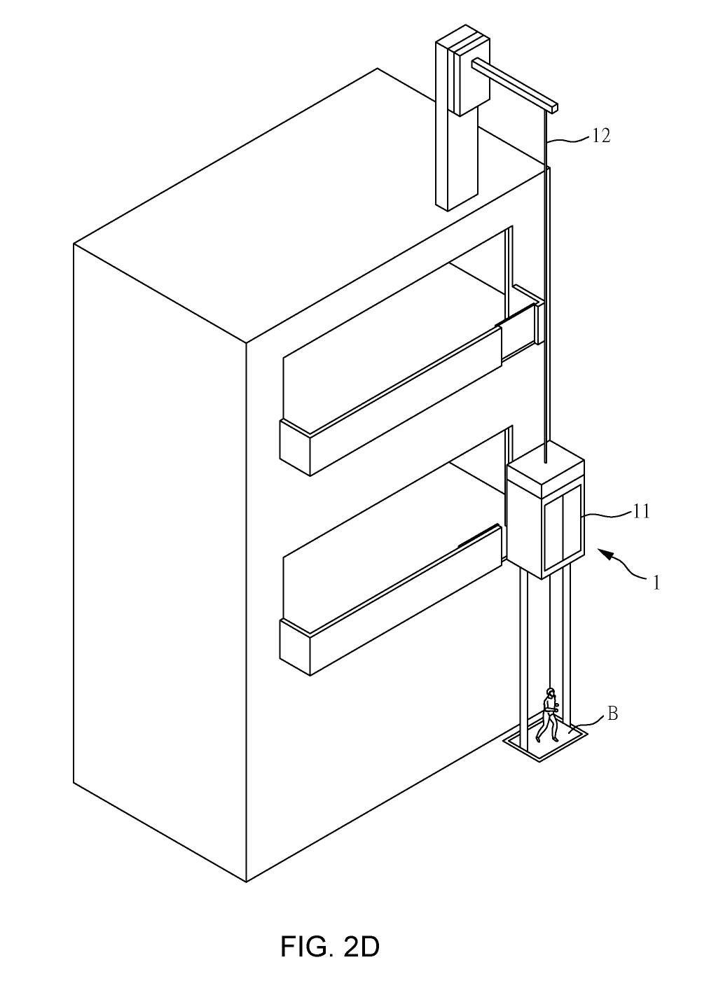

Referring to FIGS. 2A-2D, schematic views are provided to illustrate the fireproof ascending/descending mobile apparatus according to the present invention is provided with an escape exit passage. The fireproof ascending/descending mobile apparatus 1 further comprises at least one escape exit passage (not shown), and the escape exit passage can be arranged to combine with an escape seat S, an escape ladder L, or a bottom panel B. Further, in addition to the devices described above for or associated with temperature lowering, burning suppressing gas, and ventilation, the fireproof-material enclosure carrier device 11 can be provided, on a bottom surface, a side surface, or a top surface, at any location thereof, with the at least one escape exit passage, so that the:users, when lowered down to the predetermined height, are allowed to further lower down or escape from the escape exit passage by means of the escape seat S or the escape ladder L, or to alternatively drop down and escape through the bottom panel B of the fireproof-material enclosure carrier device 11.

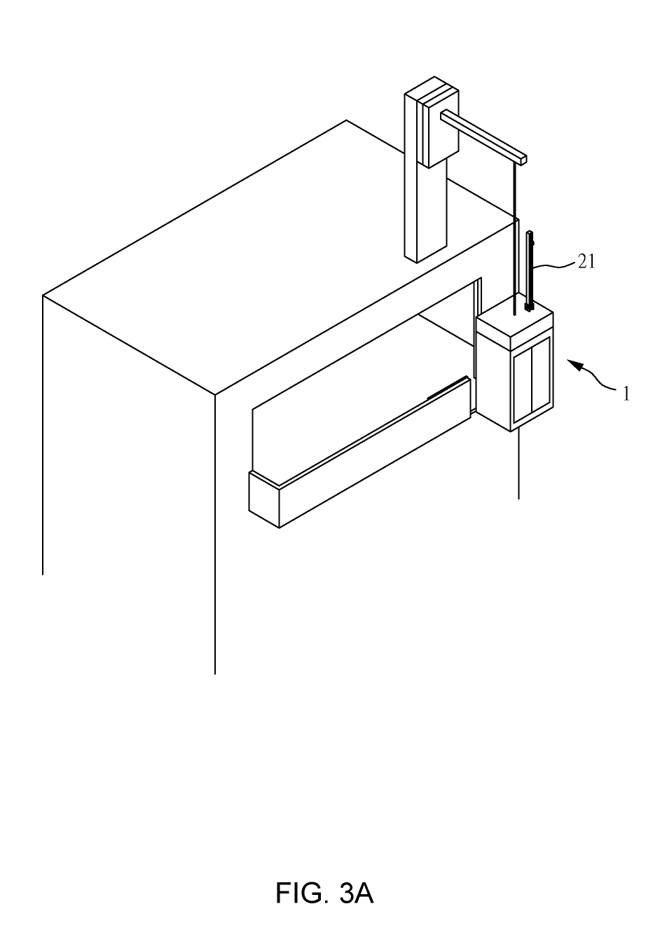

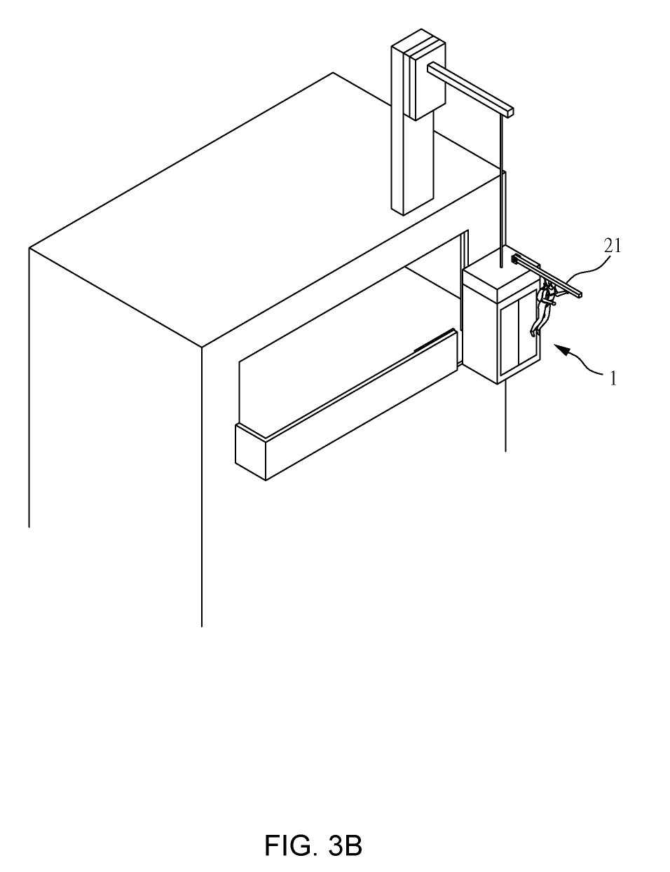

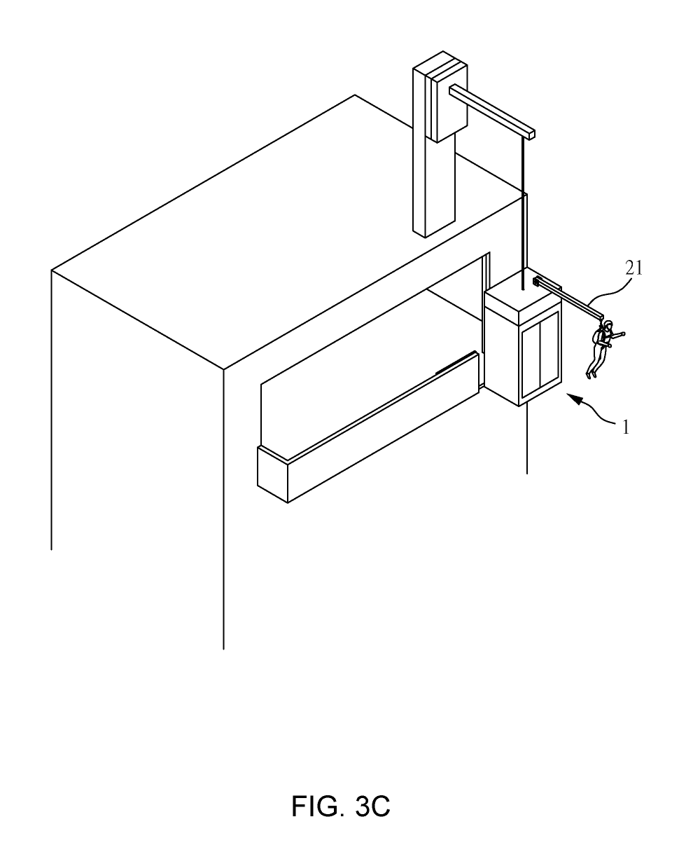

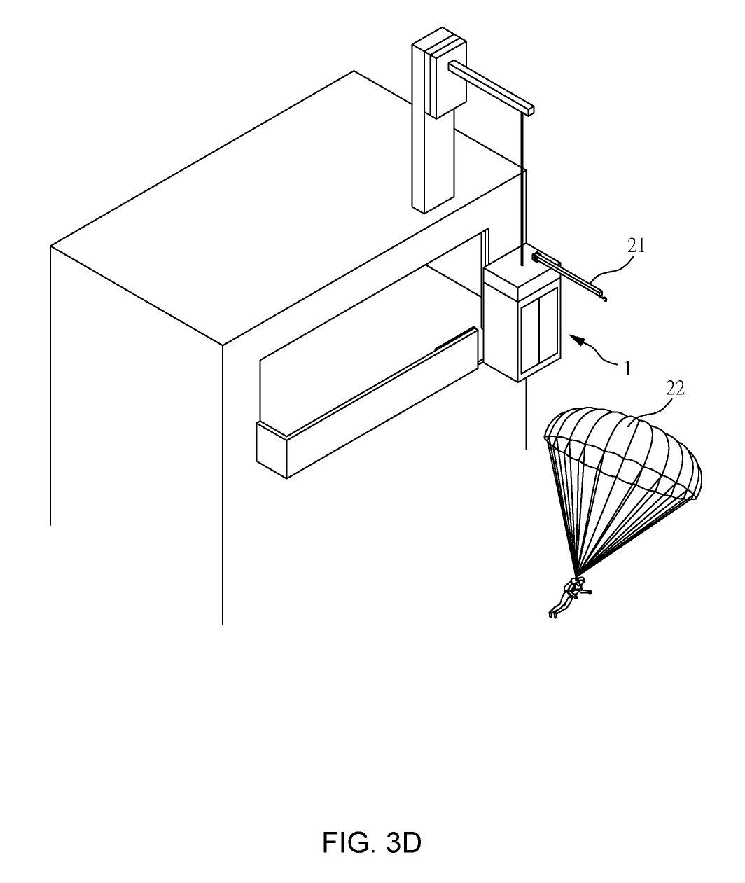

Referring to FIGS. 3A-3D, schematic views are provided to illustrate the fireproof ascending/descending mobile apparatus according to the present invention is provided with a flying device. The fireproof ascending/descending mobile apparatus 1 further comprises at least one support frame 21 and at least one flying device 22. The at least one support frame 21 is arranged on the fireproof-material enclosure carrier device 11 or is arranged on a top floor or roof of a building. The flying device 22 may use the support frame 21 as a rail for sliding or moving in order to fly in a direction away from the building. Further, the support frame 21 comprises at least one inclined rail and a user may wear or hold or put the flying device 22 on the body and to fit to attach to or movably couple to the inclined rail so that the user who wears, holds, or puts the flying device 22 moves through sliding to a terminal end of the support frame 21, the flying device 22 is automatically triggered to detach from the support frame 2l for slow descending. The flying device 22 comprises a hand glider or a parachute. Taking a parachute as an example, after detaching from the support frame 21, the parachute is automatically opened by means of air floatation. Further, the user may alternatively wear an air floatation activated object fall speed-reducing system (not shown) to directly jump off the building or the reproof-material enclosure carrier device 11 as an escape measure.

In summary, the present invention provides a fireproof ascending/descending mobile apparatus that includes all sorts of functions for protecting users, preventing the users from injury caused by high temperature flames and smoke, and also for detecting environmental changes and activating, in advance, a situation-responding mechanism as early as possible when a fire occurs in order to protect and help the users to escape immediately. Further, the present invention comprises an uninterruptible power system, which continuously supplies electrical power to maintain the operation of the drive device even when the fire causes power failure.

What is claimed is:

1. A fireproof ascending/descending mobile apparatus, comprising:
at least one fireproof-material enclosure carrier device;
at least one fireproof-material support device;
at least one drive device, which drives the at least one fireproof-material enclosure carrier device to cause the at least one fireproof-material enclosure carrier device to move on the at yeast one fireproof-material support device and is arranged in the at least one fireproof-material enclosure carrier device;
at least one uninterruptible power system, which is electrically connected with the at least one drive device and is arranged in the at least one fireproof-material enclosure carrier device; and
at least one position controller, which is connected with the at least one drive device to control a position of the at least one fireproof-material enclosure carrier device and is arranged in the at least one fireproof-material enclosure carrier device.

2. The fireproof ascending/descending mobile apparatus according to claim 1, wherein the fireproof-material support device comprises a fireproof-material support rail and/or a fireproof-material suspension cable.

3. The fireproof ascending/descending mobile apparatus according to claim 2, wherein the fireproof-material support rail and/or the fireproof-material suspension cable is arranged in interior and/or exterior of a building.

4. The fireproof ascending/descending mobile apparatus according to claim 2, wherein the fireproof-material support rail comprises a curved rail, an extendible rail, and/or a combination rail.

5. The fireproof ascending/descending mobile apparatus according to claim 3, further comprising at least one temperature sensor and/or at least one flame sensor, which is arranged in exterior of the at least one fireproof-material enclosure carrier device and/or the interior of the building to detect an environmental temperature of the exterior of the at least one fireproof-material enclosure carrier device and/or the interior of the building.

6. The fireproof ascending/descending mobile apparatus according to claim 5, wherein the at least one temperature sensor or the at least one flame sensor is electrically or non-electrically connected with the at least one drive device to drive, according to the environmental temperature, the at least one drive device to at least one floor of the building.

7. The fireproof ascending/descending mobile apparatus according to claim 5, further comprising at least one temperature lowering device, which is arranged in the at least one fireproof-material enclosure carrier device and is connected with the at least one temperature sensor and/or the at least one flame sensor to activate on according a preset temperature of the at least one temperature sensor and/or the at least one flame sensor.

8. The fireproof ascending/descending mobile apparatus according to claim 1, further comprising at least one air supply and filtration device, which is arranged in the at least one fireproof-material enclosure carrier device.

9. The fireproof ascending/descending mobile apparatus according to claim 8, wherein the at least one air supply and filtration device comprises at least one oxygen mask, at least on active carbon mask, and/or at least one oxygen mask.

10. The fireproof ascending/descending mobile apparatus according to claim 1, further comprising at least one ventilation device, which is arranged in the at least one fireproof-material enclosure carrier device.

11. The fireproof ascending/descending mobile apparatus according to claim 1, further comprising at least one burning suppressing gas device, which is arranged in the at least one fireproof-material enclosure carrier device.

12. The fireproof ascending/descending mobile apparatus according to claim 1, further comprising at least one remote control AI robot, including airplane and/or ground robot equipped with camera and rescue devices.

13. The fireproof ascending/descending mobile apparatus according to claim 1, further comprising at least one controller, which is connected with the at least one drive device to control a moving speed of the at least one fireproof-material enclosure carrier device.

14. The fireproof ascending/descending mobile apparatus according to claim 1, further comprising at least one side door, which is connected with the at least one mechanical escape device, including stair or slide.

15. A fireproof ascending/descending mobile apparatus, comprising:
at least one fireproof-material enclosure carrier device;
at least one fireproof-material support device;
at least one drive device, which drives the at least one fireproof-material enclosure carrier device to cause the at least one fireproof-material enclosure carrier device to move on the at least one fireproof-material support device and is arranged in at least one fireproof-material enclosure;
at least one uninterruptible power system, which is electrically connected with the at least one drive device and is arranged in the at least one fireproof-material enclosure;
at least one first wireless control device, which is arranged in the at least one fireproof-material enclosure carrier device to transmit at least one signal; and
at least one second wireless control device, which is arranged in the at least one fireproof-material enclosure and is connected with the at least one drive device to receive the at least one signal to control a position of the at least one fireproof-material enclosure carrier device.
